(19) United States
(12) Patent Application Publication
(10) Pub. No.: US 2006/0287517 A1
(43) Pub. Date: Dec. 21, 2006

(54) Preparation of wood pulps with caustic pretreatment for use in the manufacture of cellulose acetates and other organic esters

(76) Inventors: Linfu Wang, Blacksburg, VA (US); Henry P. Stogner, Bluefield, WV (US); Charles Toney, Newport, VA (US); Chuck Kizer, Blacksburg, VA (US); Bill Batson, Pearisburg, VA (US)

Correspondence Address: HAMMER & HANF, PC, 3125 SPRINGBANK LANE, SUITE G, CHARLOTTE, NC, 28226, US

(21) Appl. No.: 11/155,133

(22) Filed: Jun. 16, 2005

(51) Int. Cl. C08B 1/02

(52) U.S. Cl. 536/71

(57) ABSTRACT

A process for making cellulose acetate or cellulose esters which pretreats a wood pulp prior to acetylation or esterification is disclosed. The pretreatment of the wood pulp includes the mixture of wood pulp into a caustic solution to form a suspension of wood pulp. The suspension of wood pulp is separated from the caustic solution to form a cake. The cake is washed with an acid to obtain an acid and cellulose cake having a low water content. The acid and cellulose cake is then acetylated or esterifed to form cellulose acetate or other cellulose esters.

### BACKGROUND OF THE INVENTION

The present invention provides a process for making cellulose acetate or cellulose esters which pretreats a wood pulp prior to acetylation or esterification.

Cellulose acetate is an organic-acid ester of cellulose. Cellulose acetate is used for various purposes such as the fiber material for clothes and cigarette filters. The production of cellulose acetate and other organic esters of cellulose are important industries within their target markets.

Production of cellulose acetate and other cellulose esters needs a supply of high-quality cellulose feedstock. One source of high quality feedstock is cotton linters, however this source is expensive and in limited supplies. An abundant source of feedstock is wood pulp, which is less expensive than cotton linters. Wood pulp is also used in the manufacture of paper. However, the cellulose feedstock quality obtained from wood pulp varies widely, with the higher quality feedstocks being more expensive than the lower quality feedstocks.

In the production of cellulose acetate and other cellulose esters derived from wood pulp, the best wood pulp feedstocks have low hemi-cellulose content and low levels of organic solvent extractives (also called resins), and lignins. Hardwood pulp feedstocks having a hemi-cellulose content of 1 to 2% are preferred. However, soft wood pulp feedstocks having a hemi-cellulose content of up to 3% can be used. Traditionally wood pulp feedstocks having a hemi-cellulose content of more than 3% proved problematic such as standard viscose wood pulps. Wood pulp feedstocks traditionally used in the manufacture of paper have a hemi-cellulose content of 15 to 20% and are less expensive but have proved to be a poor choice for the manufacture of cellulose acetate and other cellulose esters.

In the production of cellulose esters, the esterification reaction between cellulose and a corresponding anhydride is carried out in the presence of organic acid solvent, with a small amount of inorganic acid used as catalyst. An example is the reaction of cellulose with acetic anhydride in the presence of acetic acid, with sulfuric acid used as catalyst. Other cellulose esters produced from this esterification reaction can include cellulose acetates, cellulose propionates, cellulose butyrates, cellulose valerate, cellulose formate etc. Copolymers of acetate-propionates or butyrates or valerates or formates can also be produced using mixtures of corresponding anhydrides.

In the case of cellulose acetates, the reaction product that is formed first is primary cellulose acetate where all three of the hydroxyl groups of the cellulose have been acetylated. That is, the degree of substitution (D.S.) is 3.0. This product is not isolated but is converted by hydrolysis to the secondary acetate (D.S.=nominally 2.4). This is done by the controlled heating of the reaction mixture after the partial neutralization of the acid catalyst. The secondary acetate is a useful material since it is soluble in the relatively non-toxic and easily recovered acetone solvent. The primary cellulose acetate or cellulose triacetate is useful in the production of film, which can be used in LCD (Liquid crystal displays), or in the production of fiber. Similar reaction processes can also be used in the production of other cellulose esters such as cellulose propionates, cellulose butyrates, and acetate copolymers.

U.S. Pat. No. 6,057,438 discusses a process for upgrading paper-grade hard wood pulp produced by the kraft process to dissolving grade pulp which uses a caustic treatment at elevated temperatures, followed by an enzyme treatment, followed by another caustic treatment at elevated temperatures. Unlike this reference, the instant invention caustic treatment can be run at room temperature and no enzyme step is required. The instant invention only requires one treatment of caustic, whereas this reference requires two treatments of the pulp with caustic at elevated temperatures. Also, the instant invention can be used on both hardwood and softwood pulps produced by either a kraft process or a sulfite process.

World Patent WO 2004/067572 discusses a process where wood pulp is treated with a caustic solution followed by a wash with an alcohol extraction agent. In this reference, the caustic solution is recycled during the process. The instant invention differs from this process by not using an alcohol extraction agent, but using water and acetic acid washing. This reference is concerned with the production of cellulose xanthogenate or viscose and fails to discuss the production of cellulose acetate.

### SUMMARY OF THE INVENTION

A process for making cellulose acetate or cellulose esters which pretreats a wood pulp prior to acetylation or esterification is disclosed. The pretreatment of the wood pulp includes the mixture of wood pulp into a caustic solution to form a suspension of wood pulp. The suspension of wood pulp is separated from the caustic solution to form a cake. The cake is washed with an acid to obtain an acid and cellulose cake. The acid and cellulose cake is then acetylated or esterifed to form cellulose acetate or other cellulose esters. This cake may also be washed with water in another embodiment, before it is washed with an acid.

### DETAILED DESCRIPTION OF THE INVENTION

The present invention is directed to a process for making cellulose acetate or cellulose esters which pretreats a wood pulp prior to acetylation or esterification. The pretreatment of the wood pulp includes the mixture of wood pulp into a caustic solution to form a suspension of wood pulp. The initial form of the wood pulp can be either bale, sheet, or roll. Physical pulp sheet properties such as uniformity, density, hardness and moisture content etc are not significant factors.

After pretreatment, the suspension of wood pulp is separated from the caustic solution to form a cake. In one embodiment of the invention, the cake is washed with acetic acid to obtain an acetic acid and cellulose cake. The acetic acid and cellulose cake is then acetylated to form cellulose acetate.

The caustic solution used in this process is from 1% to 50% by weight caustic. In another embodiment of the invention the caustic solution used in this process is from 1% to 18% by weight caustic. Any caustic solution may be used, which includes any strong alkaline material. An example of a caustic solution is caustic soda or sodium hydroxide.

While this process will work on a wide range of wood pulp grades, in the production of cellulose acetate the primary value is for wood pulp having an alpha cellulose content of 96% or less. However, even high grade wood pulps having an alpha cellulose content of 98% or less may benefit from the caustic treatment to further enhance the pulps properties and thus yield a cellulose acetate having superior properties. The wood pulps can be composed of different wood species or combinations of species from either hardwoods or softwoods. Hardwood examples include but not limited to oak, gum, hickory, maple, beech, birch, aspen, and eucalyptus, etc. Softwood examples include but not limited to pines, spruce, fir, larch, and hemlock etc. The wood pulps can be made by a prehydrolysis kraft process, kraft process, sulfite process, or other pulping processes.

The process for making cellulose acetate described above may be modified in another embodiment of the invention to further comprise the step of washing the cake with water to obtain a washed cellulose cake. Subsequently this water-washed cellulose cake is washed with acetic acid to obtain an acetic acid and cellulose cake prior to acetylation.

In this process for making cellulose acetate in one embodiment no enzymes are used in the pretreatment process.

The process can be run from cool processing temperatures to elevated processing temperatures depending on the starting wood pulp and desired results in the end. Generally the caustic solution is added at a temperature ranging from the freezing point of the caustic solution to 180° C. In another embodiment of the invention, the caustic solution is added at a temperature ranging from 0° C. to 100° C. The caustic solution can be added at room temperature. Room temperature is defined to be an ambient temperature ranging from 20° C. to 25° C. It has been found that the addition of the caustic solution at a temperature ranging from 2° C. to 10° C. works well on wood pulps having a high hemi-cellulose content but low levels of extractives, resins and lignins. It should be noted, that with some cases where the caustic solution is at the lower end of the range and where the reaction temperatures are in excess of 100° C. the reaction may have to be run in a pressurized reaction vessel at a pressure in excess of atmospheric pressure. A pressurized reaction vessel can also be used over the entire reaction range employing the use of pressures in excess of atmospheric pressure.

In another embodiment of the invention a process for making cellulose acetate which pretreats a wood pulp prior to acetylation. The pretreatment of the wood pulp includes the mixture of wood pulp into a caustic solution to form a suspension of wood pulp. The suspension of wood pulp is separated from the caustic solution to form a cake. The cake is then washed with water to obtain a washed cellulose cake. The washed cellulose cake is washed with acetic acid to obtain an acetic acid and cellulose cake. The acetic acid and cellulose cake is then acetylated to form a cellulose acetate.

In another embodiment of the invention a process for making cellulose acetate which pretreats a wood pulp prior to acetylation. The wood pulp has an alpha cellulose level of 96% or less. The pretreatment of the wood pulp includes the mixture of wood pulp into a caustic solution to form a suspension of wood pulp. The suspension of wood pulp is separated from the caustic solution to form a cake. The cake is then washed with water to obtain a washed cellulose cake. The washed cellulose cake is washed with acetic acid to obtain an acetic acid and cellulose cake. The acetic acid and cellulose cake is then acetylated to form a cellulose acetate.

In the embodiments described above the step of separating the pulp from the solution can be performed by any means. For example the separation step may be performed by filtering, centrifuge or any other means of solid-liquid separation. Filtration can be vacuum filtration or pressure filtration. Separation may also be achieved by mechanical squeezing and pressing or other solid/liquid separation technology.

In the embodiments described, after mixing wood pulp into a caustic solution a first suspension of wood pulp is obtained. Typically this suspension of wood pulp in caustic is made up of 1% to 18% wood pulp by weight of in the caustic solution. When this suspension undergoes the separation step one obtains a cake. This cake comprises 10 to 70% by weight cellulose and 90 to 30% caustic solution. In one of the embodiments of the invention, this cake may comprise 20 to 60% by weight cellulose and 80 to 40% caustic solution. This cake may be subjected to a water wash to displace the caustic solution. The water wash produces a washed cake, where the washed cake comprises 10 to 95% by weight cellulose and 90 to 5% water by weight. In one of the embodiments of the invention, this cake may comprise 20 to 60% by weight cellulose and 80 to 40% by weight water. Either the cake or the washed cake may be washed again with acetic acid to produce an acetic acid and cellulose cake. This acetic acid and cellulose cake may comprise 10 to 70% by weight cellulose, 0 to 8% water by weight and 90 to 22% acetic acid by weight. In one of the embodiments of the invention, this cake may comprise 20 to 60% by weight cellulose, 0 to 7% by weight water and 80 to 33% by weight acetic acid.

In this process for making cellulose acetate in one embodiment no enzymes are used in the pretreatment process.

Generally the caustic solution is added at a temperature ranging from the freezing point of the caustic solution to 180° C. The caustic solution can be added at room temperature. Room temperature is defined to be an ambient temperature ranging from 20° C. to 25° C.

The invention also provides an intermediary cake of cellulose, used in manufacturing cellulose acetate. This cellulose cake is prepared by the steps of: pretreating wood pulp, wherein the pretreating comprises: wood pulp mixed into a caustic solution; the pulp is separated from the solution to form a cake; and the cake is washed with acetic acid to obtain an acetic acid and cellulose cake. This cake comprises 10 to 70% by weight cellulose and 90 to 30% acetic acid by weight.

In another embodiment of the invention, this intermediary cake may be produced by the further steps of taking the cake and washing it with water to obtain a washed cellulose cake. The washed cellulose cake comprises 10 to 95% by weight cellulose and 90 to 5% water by weight. The washed cellulose cake would then be washed with acetic acid to obtain an acetic acid and cellulose cake. The acetic acid and cellulose cake comprises 10 to 70% by weight cellulose, 0 to 8% water by weight and 90 to 22% acetic acid by weight.

The cake of cellulose obtained by this process then may be acetylated to form a primary cellulose acetate. The acetylation process involves reacting the cellulose cake and acetic acid with acetic anhydride in acetic acid with a small amount of a strong inorganic acid, such as sulfinuric acid. The primary cellulose acetate is then hydrolyzed to form a secondary cellulose acetate in a hydrolysis mixture. Water either with or without acetic acid is then added to the secondary cellulose acetate and hydrolysis mixture with mixing to form a solid polymer which is referred to as “flake.” This flake is then used to produce an extruded cellulose acetate product such as fibers, filter tow, films or plastics. By use of this pretreatment process to manufacture flake one of the benefits is an increase in the filterability, as represented by plugging value, of acetate flake in 9% acetone solution at 14.1 kilogram-force/square centimeter (200 psi) by at least 15% over flake produced from the same grade of wood pulp that did not undergo the pretreatment of the wood pulp. Meanwhile other properties such as solution color, haze and hemicellulose acetate content, etc. are also reduced as compared to acetate flake made from wood pulp, which is not pretreated with the caustic solution.

### EXAMPLES

Caustic Pretreatment

Selected amounts of caustic solutions with different concentration were added into a beaker, followed by adding the selected amount of wood pulps. Then the suspension was stirred for 15 min, followed by filtration through a Buchner funnel under vacuum. The obtained cake was washed in the beaker with water 3 times, followed by 3 acetic acid washes. The cellulose-acid cake was then acetylated by a standard bench acetylation technique.

Bench Acetylation

Bench acetylation is a dilute, isothermal laboratory acetylation that is run to completion as cellulose triacetate in acetic acid. Acetylation rate and completeness of acetylation are determined by measuring the acetic acid solution haze. The degree of solution clarity is a measurement of solution quality.

Definitions:

| | | | | | | | |
|---|---|---|---|---|---|---|---|
| | Caustic | Caustic | Time | | | | |
| | Conc | Temp | to peak | | | | |
| Sample | (wt %) | (° C.) | (min) | H₀ | H₁ | H_{1C} | .H_{1C} |

BENCH ACETYLATION RESULTS OF
LOW-GRADE ACETATE PULPS

Acetate Grade Pulps - Hardwoods

| | | | | | | | |
|---|---|---|---|---|---|---|---|
| Sample 1 Control | | | 42.4 | 2.5 | 3.2 | 2.5 | 0.7 |
| Sample 1 CP | 5 | 22 | 16.3 | 0.9 | 0.9 | 0.8 | 0.1 |

Acetate Grade Pulps - Softwoods

| | | | | | | | |
|---|---|---|---|---|---|---|---|
| Sample 2 Control | | | 23.6 | 4.3 | 5.3 | 2.5 | 2.8 |
| Sample 2 CP | 5 | 22 | 19.5 | 2.1 | 3.5 | 2.2 | 1.3 |
| Sample 3 Control | | | 31.3 | 5.8 | 8.2 | 5.6 | 2.6 |
| Sample 3 CP | 5 | 22 | 23.5 | 2.3 | 2.8 | 2.3 | 0.5 |

CP—caustic pretreatment, same as follows.

BENCH ACETYLATION RESULTS OF
STANDARD VISCOSE GRADE PULPS

| | | | | | | | |
|---|---|---|---|---|---|---|---|
| Sample Control | | 22 | 45.5 | 4.3 | 6.8 | 3.4 | 3.4 |
| Sample 1 CP | 18 | 22 | 10.0 | 1.4 | 1.7 | 1.4 | 0.3 |
| Sample 2 CP | 9 | 22 | 9.5 | 1.2 | 1.7 | 1.6 | 0.1 |
| Sample 3 CP | 4.5 | 22 | 11.7 | 1.7 | 1.8 | 1.2 | 0.6 |
| Sample 4 CP | 3 | 22 | 11.9 | 1.9 | 2.0 | 1.7 | 0.3 |
| Sample 5 CP | 4.5 | 100 | 12.2 | 2.1 | 1.8 | 1.4 | 0.4 |
| Sample 6 CP | 4.5 | 4 | 9.3 | 1.1 | 1.4 | 1.3 | 0.1 |

T_{P} = Time to Peak, or Time to Break. T_{P} is a measure of the acetylation rate as determined by the time in minutes to the break in the acetylation haze curve. Typically, thicker walled, larger fibers (softwoods) and lower purity pulps will have longer acetylation times in both the bench acetylation and commercial processes.
H₀ = Haze of the acid solution 10 minutes after T_{P}. H₀ represents acetylation T_{P} plus 10 minutes clear time. Lower Haze means a less turbid solution and is generally considered better. Haze is affected by both the quality of the acetylation reaction and the level and type of hemicellulose content.
H₁ = Equals Haze after 1 day for the sample H₀. Again, each specific pulp will have its own baseline Haze. (H₁ − H₀) indicates how much material phased out of the acetic acid solution on standing and cooling for 1 day. Material that phases out of solution on cooling is gelatinous. Lower is better.
H_{1C} = Equals the haze remaining after centrifuging. H_{1C} indicates the acid soluble and small gel phase of the sample, with hemicellulose acetates being the one main contributor. A lower number is better.
Δ H_{1C} = Delta H_{1C} = (H₁ − H_{1C}) equals the amount of material that centrifuges out of the one day sample. Δ H_{1C} is nominally proportional to plugging value. Lower is better.

Laboratory Bench Reactor Process

Laboratory acetylation bench reactor process was used to mimic the commercial cellulose acetate manufacture. The product is cellulose diacetate or acetate flake. The main properties of acetate flake include but not limited to:

LABORATORY BENCH REACTOR RESULTS
OF DIFFERENT WOOD PULPS

| | Caustic | Caustic | | | | | |
|---|---|---|---|---|---|---|---|
| | Conc | Temp | PV | Haze | Haze | Color | GPC |
| Sample | (wt %) | (° C.) | (g/cm\hat{ }2) | 1 | 2 | (YI) | PH-1 |

Acetate Grade Pulps

| | | | | | | | |
|---|---|---|---|---|---|---|---|
| Sample 1 | — | — | 37 | 15.90 | 4.71 | 4.63 | 1.98 |
| Control | | | | | | | |
| Sample 1 CP | 3 | 22 | 114 | 10.80 | 5.25 | 4.47 | 0.97 |

Viscose Grade Pulps

| | | | | | | | |
|---|---|---|---|---|---|---|---|
| Sample | — | — | 29 | 25.13 | 6.27 | 6.84 | 2.80 |
| Control | | | | | | | |
| Sample 1 CP | 5 | 22 | 36 | 11.70 | 5.54 | 4.53 | 0.82 |
| Sample 2 CP | 5 | 40 | 37 | 11.70 | 5.52 | 5.47 | 1.16 |
| Sample 3 CP | 5 | 60 | 68 | 13.75 | 6.11 | 4.94 | 1.20 |
| Sample 4 CP | 5 | 90 | 75 | 13.40 | 5.27 | | 1.14 |

PV- plugging value of acetate flake in 9% acetone solution at 200 psi. 200 pound-force/square inch (psi) = 14.06 kilogram-force/square centimeter. It is indication of the filterability of the solution. The higher the PV number, the better the performance of the product.
Haze 1: the haze of acetate flake in acetone/water solution. Lower is better.
Haze 2: the haze of acetate flake in dichloromethane/methanol solution. The lower is better.
YI: yellowness index. This is related to the flake color. A lower number indicates a better result.
GPC (Gel Permeation Chromatograph) prehump 1 value: This is related to the content of hemicellulose acetate in the acetate flake. The lower is better.

What is claimed is:

1. A process for making cellulose acetate or other cellulose esters comprising the steps of:
pretreating wood pulp, wherein said pretreating further comprises:
mixing wood pulp into a caustic solution;
separating the pulp from the solution to form a cake;
washing said cake with acetic acid to obtain a pretreated wood pulp; and
acetylating or esterifying said pretreated wood pulp to form cellulose acetate or other cellulose esters.

2. The process for making cellulose acetate according to claim 1 where the wood pulps have an alpha cellulose content of 98% or less.

3. The process for making cellulose acetate according to claim 1 where the wood pulps can be composed of different wood species or combinations of species from either hardwoods or softwoods;
where hardwoods are selected from the group consisting of: oak, gum, hickory, maple, beech, birch, aspen, and eucalyptus; and
where softwoods are selected from the group consisting of: pines, spruce, fir, larch, and hemlock.

4. The process for making cellulose acetate according to claim 1 where the wood pulps can be made by a process selected from the group consisting of:
prehydrolysis kraft process, kraft process, or sulfite process.

5. The process for making cellulose acetate according to claim 1 where said caustic solution is from 1% to 50% by weight caustic.

6. The process for making cellulose acetate according to claim 1 further comprising the step of washing said cake with water to obtain a washed cellulose cake; and
washing said washed cellulose cake with acetic acid to obtain an acetic acid and cellulose cake prior to acetylation.

7. The process for making cellulose acetate according to claim 1 where no enzymes are used in the pretreatment process.

8. The process for making cellulose acetate according to claim 1 where the caustic solution is added at a temperature ranging from a freezing point of the caustic solution to 180° C.

9. The process for making cellulose acetate according to claim 8 where the caustic solution is added at room temperature.

10. The process for making cellulose acetate according to claim 8 where the caustic solution is added at a temperature ranging from 0° C. to 110° C.

11. A process for making cellulose acetate or other cellulose esters comprising the steps of:
pretreating wood pulp, wherein said pretreating further comprises:
mixing wood pulp into a caustic solution;
separating the pulp from the solution to form a cake;
washing said cake with water to obtain a washed cellulose cake; and
washing said washed cellulose cake with acetic acid or other corresponding acid to obtain a pretreated wood pulp; and
acetylating or esterifying said pretreated wood pulp to form cellulose acetate or other cellulose esters.

12. The process for making cellulose acetate according to claim 11 where the wood pulp has an alpha cellulose content of 96% or less.

13. The process for making cellulose acetate according to claim 11 where said caustic solution is from 1% to 50% by weight caustic.

14. The process for making cellulose acetate according to claim 11 where no enzymes are used in the pretreatment process.

15. The process for making cellulose acetate according to claim 11 where the caustic solution is added at a temperature ranging from a freezing point of the caustic solution to 180° C.

16. The process for making cellulose acetate according to claim 15 where the caustic solution is added at room temperature.

17. The process for making cellulose acetate according to claim 15 where the caustic solution is added at a temperature ranging from 2° C. to 10° C.

18. A process for manufacture of cellulose acetate or other cellulose esters from wood pulp comprising a pretreatment of the pulp comprising the steps of:
mixing wood pulp into a caustic solution, where said wood pulp has an alpha cellulose content of 98% or less;
separating the pulp from the solution to form a cake;
washing said cake with water to obtain a washed cake; and
washing said washed cake with acetic acid or other corresponding acid to obtain a pretreated wood pulp; and
acetylating or esterifying said pretreated wood pulp to form cellulose acetate or other cellulose esters.

19. The process for making cellulose acetate according to claim 18 where said caustic solution is from 1% to 50% by weight caustic.

20. The process for making cellulose acetate according to claim 18 where separating the pulp from the solution is performed by filtering, or centrifuge, or mechanical squeezing and pressing, or other solid-liquid separating methods.

21. The process for making cellulose acetate according to claim 18 where after mixing wood pulp into a caustic solution a first suspension of wood pulp is obtained of 1% to 18% wood pulp by weight of in said caustic solution.

22. The process for making cellulose acetate according to claim 18 where said cake comprises 10 to 70% by weight cellulose and 90 to 30% caustic solution.

23. The process for making cellulose acetate according to claim 22 where said cake comprises 20 to 50% by weight cellulose and 80 to 50% caustic solution.

24. The process for making cellulose acetate according to claim 18 where said washed cake comprises 10 to 95% by weight cellulose and 90 to 5% water by weight.

25. The process for making cellulose acetate according to claim 24 where said washed cake comprises 20 to 50% by weight cellulose and 80 to 50% water by weight.

26. The process for making cellulose acetate according to claim 18 where said pretreated wood pulp comprises 10 to 70% by weight cellulose, 0 to 8% water by weight, and 90 to 22% acetic acid.

27. The process for making cellulose acetate according to claim 26 where said pretreated wood pulp comprises 20 to 60% by weight cellulose, 0 to 7% water by weight and 80 to 33% acetic acid.

28. The process for making cellulose acetate according to claim 18 where no enzymes are used in the pretreatment process.

29. The process for making cellulose acetate according to claim 18 where the caustic solution is added at a temperature ranging from a freezing point of the caustic solution to 180° C.

30. The process for making cellulose acetate according to claim 29 where the caustic solution is added at room temperature.

31. A cake of cellulose, used in manufacturing cellulose acetate or other cellulose esters prepared by a process having the steps of:
pretreating wood pulp, wherein said pretreating further comprises:
mixing wood pulp into a caustic solution;
separating the pulp from the solution to form a cake;
washing said cake with acetic acid or other corresponding acid to obtain an acid-cellulose cake.

32. The cake of cellulose according to claim 31, where said cake comprises 10 to 70% by weight cellulose, 0 to 8% water by weight and 90 to 22% acetic acid by weight.

33. The cake of cellulose according to claim 32, where said cake comprises 20 to 60% by weight cellulose, 0 to 7% water by weight and 80 to 33% acetic acid by weight.

34. The cake of cellulose according to claim 31 used in manufacturing cellulose acetate or other cellulose esters prepared by the further steps of:
washing said cake with water to obtain a washed cellulose cake; and
washing said washed cellulose cake with acetic acid or other corresponding acid to obtain an acid-cellulose cake.

35. The cake of cellulose according to claim 34, where said washed cellulose cake comprises 10 to 95% by weight cellulose and 90 to 5% water by weight.

36. The cake of cellulose according to claim 34, where said acetic acid and cellulose cake comprises 10 to 70% by weight cellulose, 0 to 8% water by weight and 90 to 22% acetic acid by weight.

37. A cellulose acetate flake, used in manufacturing cellulose acetate product prepared by a process having the steps of:
mixing wood pulp into a caustic solution;
separating the pulp from the solution to form a cake;
washing said cake with acetic acid to obtain an acetic acid and cellulose cake;
acetylating said acetic acid and cellulose cake to form a primary cellulose acetate;
hydrolyzing said primary cellulose acetate to form a secondary cellulose acetate in a hydrolysis mixture; and
adding water either with or without acetic acid to said secondary cellulose acetate and hydrolysis mixture to form cellulose acetate flake.

38. The cellulose acetate flake according to claim 37 used in manufacturing cellulose acetate prepared by the further steps of:
washing said cake with water to obtain a washed cellulose cake; and
washing said washed cellulose cake with acetic acid to obtain an acetic acid and cellulose cake.

39. The cellulose acetate flake according to claim 37 used in manufacturing cellulose acetate where plugging value of acetate flake in 9% acetone solution at 14.06 kilogram-force/square centimeter (200 psi) is improved by at least 15%.

40. The cellulose acetate flake according to claim 39 used in manufacturing cellulose acetate where other properties selected from the group of: solution color, haze, hemicellulose acetate content and combinations thereof, are improved.

41. A process used to improve properties of cellulose acetate flake, used in manufacturing cellulose acetate comprising the steps of:
mixing wood pulp into a caustic solution;
separating the pulp from the solution to form a cake;
washing said cake with acetic acid to obtain an acetic acid and cellulose cake;
acetylating said acetic acid and cellulose cake to form a primary cellulose acetate;
hydrolyzing said primary cellulose acetate to form a secondary cellulose acetate in a hydrolysis mixture;
adding water either with or without acetic acid to said secondary cellulose acetate and hydrolysis mixture to form cellulose acetate flake;
where plugging value of acetate flake in 9% acetone solution at 14.1 kilogram-force/square centimeter (200 psi) is improved by at least 15%.

42. The process according to claim 41, where other properties selected from the group of: solution color, haze, hemicellulose acetate content and combinations thereof, are improved.

43. A cellulose triacetate, used in manufacturing a cellulose triacetate product, prepared by a process having the steps of:
mixing wood pulp into a caustic solution;
separating said wood pulp from the solution to form a cake;
optionally washing said cake with water to obtain a washed cellulose cake;
washing said cake or said washed cellulose cake with acetic acid to obtain an acetic acid and cellulose cake;
acetylating said acetic acid and cellulose cake to form a cellulose triacetate.

44. Cellulose esters selected from the group of: cellulose propionates, copolymers of cellulose propionates, cellulose butyrates, copolymers of cellulose butyrates, cellulose acetate, copolymers of cellulose acetate, cellulose valerate, copolymers of cellulose valerate, cellulose formate, copolymers of cellulose formate, or combinations thereof; used in manufacturing cellulose esters products, prepared by a process having the steps of:
mixing wood pulp into a caustic solution;
separating the pulp from the solution to form a cake;
optionally washing said cake with water to obtain a washed cellulose cake;
washing said cake or said washed cellulose cake with organic acid to obtain an organic acid and cellulose cake;
esterifying said organic acid and cellulose cake to form a primary cellulose ester;
hydrolyzing said primary cellulose ester to form a secondary cellulose ester in a hydrolysis mixture;
optionally adding organic acid to said primary cellulose acetate;
adding water to said primary cellulose ester to form cellulose ester flake.
